(19) United States
(12) Patent Application Publication
(10) Pub. No.: US 2017/0011401 A1
(43) Pub. Date: Jan. 12, 2017

(54) LOCATION-BASED LOCKING AND UNLOCKING OF PAYMENT ACCOUNTS

(71) Applicant: HRB Innovations, Inc., Las Vegas, NV (US)

(72) Inventors: Greg Steinlicht, Shawnee, KS (US); Daniel D. Martin, Kansas City, MO (US)

(21) Appl. No.: 14/795,317

(22) Filed: Jul. 9, 2015

(51) Int. Cl. G06Q 20/40; H04W 4/14; H04W 4/02; G06Q 20/34

(52) U.S. Cl. CPC G06Q 20/409; G06Q 20/405; G06Q 20/342; H04W 4/14; H04W 4/02

(57) ABSTRACT

System, method and media for selectively activating and deactivating payment vehicles based on the positions of an authorized user of the account, the payment vehicle, and/or the transactions. The security and budget-control abilities of a consumer are increased by allowing the user to specify geographic regions where payment vehicle will not, or should not, be used. In such circumstances, the payment vehicle can be temporarily deactivated, thereby causing any (presumably fraudulent or undesired) transactions that may be attempted to be rejected. Such rules can be combined for finer-grained controls. The smartphone or other personal telecommunications device of the user can be used to specify the rules, determine the user's position, and/or inform the user that a transaction has been rejected based on their rules and locations.

### RELATED APPLICATION

This non-provisional patent application shares certain subject matter with concurrently filed U.S. patent application Ser. No. 14/795,230 filed Jul. 9, 2015, and entitled RULE-BASED LOCKING AND UNLOCKING OF PAYMENT ACCOUNTS, and with previously filed U.S. patent application Ser. No. 14/697,101 and entitled PAYMENT VEHICLE FOR BUDGETING; U.S. patent application Ser. No. 14/697,043 entitled UNIFIED PAYMENT VEHICLE; and U.S. patent application Ser. No. 14/697,233 entitled PAYMENT VEHICLE WITH PERSONALIZED REWARDS PROGRAM, all filed Apr. 27, 2015. The identified patent applications are hereby incorporated by reference in their entirety into the present application.

### BACKGROUND

1. Field

Embodiments of the invention generally relate to payment systems, and more particularly to a payment vehicle which can automatically be activated and deactivated (i.e., locked and unlocked) based on the locations of the user, the payment vehicle and/or a potential transaction.

2. Related Art

Traditionally, payment vehicles (such as, for example, credit cards, debit cards, and prepaid cards) are shipped to the user in a deactivated state. Once the user receives and activates the card, typically by calling the issuing bank, it can be used to make purchases. In the event that the card is stolen, the user can report the theft in order to have the card deactivated and a replacement issued. However, such activations and deactivations are rare events in the lifecycle of the payment vehicle.

At the same time, credit card fraud is on the rise. While financial institutions that issue cards can combat fraud by examining transaction patterns and rejecting transactions deemed to be suspicious, users are in the best position to know when an authorized transaction is being made. Accordingly, there is a need for a fraud-reduction system whereby a user can specify circumstances when they will not be making transactions so that fraudulent transactions can be automatically rejected.

### SUMMARY

Embodiments of the invention address the above problem by allowing the user to define rules for circumstances when their payment vehicle will not, or should not, be used. In such circumstances, the payment vehicle can be temporarily deactivated, thereby causing any (presumably fraudulent or undesired) transactions that may be attempted to be rejected. In particular, in a first embodiment, the invention includes a system for location-based activation and deactivation of a payment vehicle, comprising a user interface for allowing a user to specify a geographic region and a rule corresponding to the geographic region, a location rules data store operable to store the geographic region and the rule, a location rules engine operable to receive transaction information, determine a location for the transaction, and determine whether the transaction should be allowed or denied based at least in part on whether the location for the transaction is within the geographic region and the rule.

In a second embodiment, the invention includes a method for allowing or denying a transaction based on location, comprising the steps of receiving information for a transaction, determining a location for a user, determining a location for a payment vehicle being used to fund the transaction, and determining whether the transaction should be allowed based at least in part on a proximity between the user and the payment vehicle.

In a third embodiment, the invention includes one or more computer-readable media storing computer-executable instructions which, when executed by a processor perform a method of allowing or denying a transaction based on the location of a user, comprising the steps of receiving, from a user, an indication of a geographic region, receiving, from a point-of-sale, information for a transaction, determining a location for the user, and allowing or denying the transaction based at least in part on whether the user is within the geographic region.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts a system suitable for use with certain embodiments of the invention;

FIG. 3 depicts an exemplary interface in accordance with certain embodiments of the invention; and

FIG. 4 depicts a flowchart illustrating the operation of an exemplary method in accordance with embodiments of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

At a high level, embodiments of the invention allow for the automatic activation and deactivation of a payment vehicle (such as, for example, a credit card) based on the location of the user, the payment vehicle, and/or the transaction. A user might want to restrict the locations at which payments can be made for a variety of reasons. In some cases, a user might wish to prevent fraud by preventing transactions unless the user is present where the transaction is taking place. Alternatively, the user might want to prevent transactions from taking place in a particular location in order to better manage their finances. For example, a compulsive gambler might wish to disable their credit card when they travel to Las Vegas for business.

In order to accomplish this, the user can be presented with a mapping interface to define rules for where transactions are or are not permitted. For example, a user might be presented with a digital map on which they can draw or select regions and indicate whether transactions are allowed or prohibited with the region. The region can be small, such as a single store, or large, as in the example given above of Las Vegas. Each user may define many such regions and configure them individually or as a group. If there are multiple cards tied to a single account, regions can be applied to one card or multiple cards.

Based on the user's configurations, transactions for the account can be processed to determine whether they are in a location permitted by the user. These determinations can be made based on the location of the user, the location of the transaction and/or the location of the payment vehicle. These locations can each be determined in a variety of ways, as discussed in greater detail below.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

### Operational Environment For Embodiments of the Invention

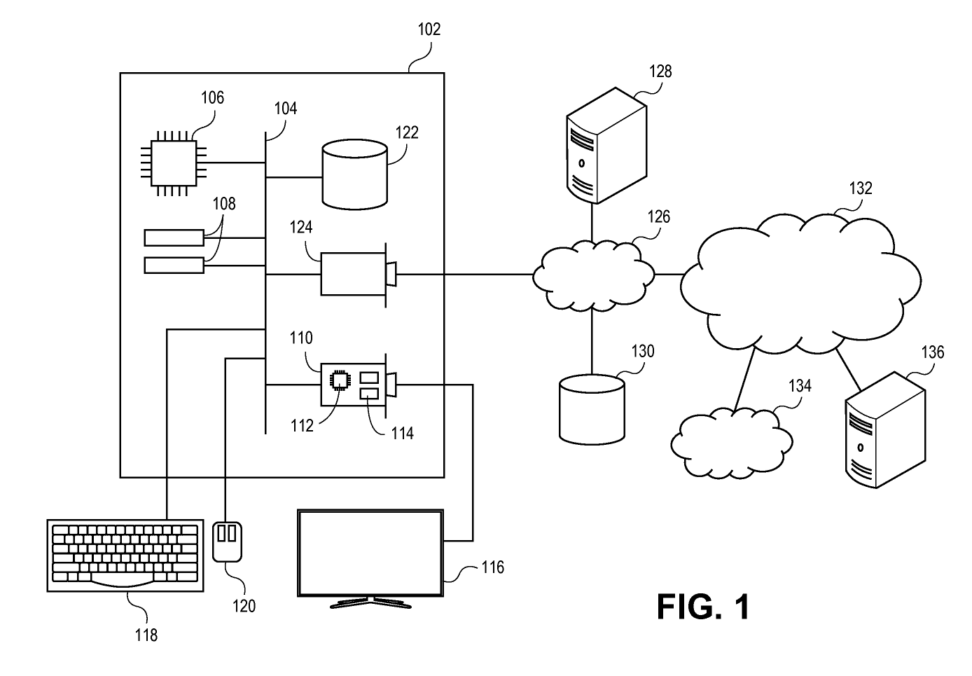

Turning first to FIG. 1, an exemplary hardware platform that for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removeably attached.

Computer-readable media include both volatile and nonvolatile media, removable and non-removable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

### Embodiments of the Invention in Operation

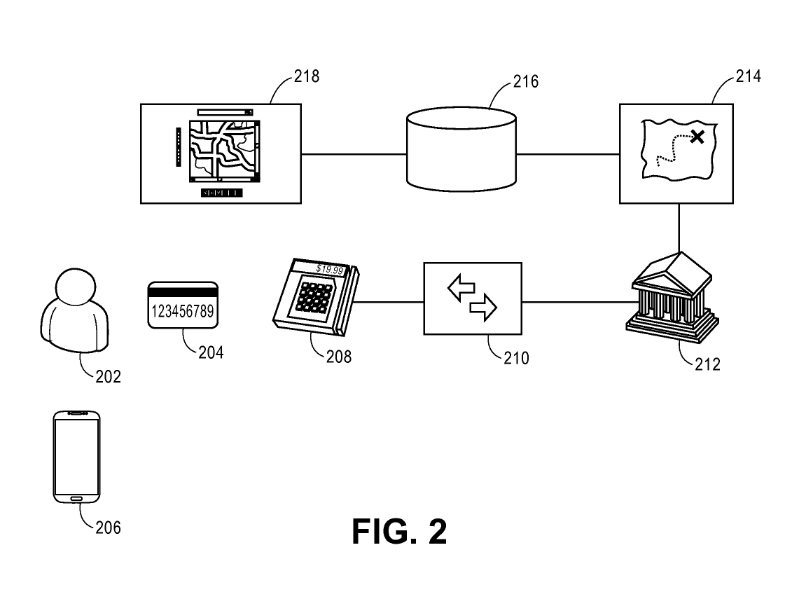

Turning now to FIG. 2, a system suitable for use with certain embodiments of the invention is depicted. Initially, user 202 is issued payment vehicle 204. In some embodiments, user 202 is an individual with an individual account. In other embodiments, user 202 is an individual with access to a joint account. In still other embodiments, user 202 is a representative with access to an organizational account. For brevity, the term “user” will be used interchangeably herein to refer to an owner of a financial account linked to payment vehicle 204, a party using payment vehicle 204 to conduct a transaction, or an individual acting on behalf of the account owner to configure rules as described below.

Payment vehicle 204 can also take on a variety of forms. In some embodiments, payment vehicle 204 is a credit card. In other embodiments, payment vehicle 204 is a debit card. In still other embodiments, payment vehicle 206 is a pre-paid card or a gift card. Similarly, payment vehicle 204 can be embodied in a variety of ways. For example, in one embodiment, payment vehicle 204 is a magnetic-stripe card. In another embodiment, payment vehicle 204 is a chip-and-PIN card. In still another embodiment, payment vehicle 204 is a mobile payment application running on a personal telecommunications device. In yet another embodiment, payment vehicle 204 has no physical embodiment, but rather is an abstract identifier (e.g., an account number or cryptological verifier) for an associated financial account. Broadly, payment vehicle 204 identifies a financial account and provides some level of verification that user 202 is authorized to access it. In some embodiments, payment vehicle 204 further includes features for determining its own location. For example, in the mobile payment application embodiment, the personal telecommunications device may include location services functionality, or a chip-and-PIN card may communicate with the point-of-sale 208 to determine its location.

In certain embodiments, user 202 may also have personal location device 206 (e.g., a smartphone, tablet, laptop computer, or smart watch). In those embodiments where payment vehicle 204 is embodied in a personal telecommunications device such as a smartphone, personal location device 206 may be the same personal telecommunications device embodying payment vehicle 204 or a different one. In some embodiments, personal location device 206 includes location services functionality allowing it to determine its position (and, by proxy, the position of user 202). For example, personal location device 206 may include a Global Positioning System (GPS) receiver. Alternatively, personal location device 206 can calculate its position using known positions for nearby cellular towers or wireless access points (e.g., Wi-Fi access points) via triangulation. Other methods of determining the location of personal location device 206, now known or later developed, are also contemplated.

Additionally, other methods may be used instead of (or in addition to) personal location device 206 to determine the location of user 202. For example, user 202 may wear a watch including location services functionality that communicates with the user's personal telecommunications device, or an inertial tracker. Broadly, embodiments of the invention contemplate any way for the location or approximate location of user 202 to be determined.

Merchant point-of-sale 208 interfaces with payment vehicle 204 on behalf of the merchant, and may take different forms depending on the form of payment vehicle 204. For example, if payment vehicle 204 is a magnetic stripe card, then merchant point-of-sale 208 may incorporate a magnetic strip reader. A single merchant point-of-sale may be able to interface with multiple forms of payment vehicle. For example, a single point-of-sale may include a magnetic stripe reader, a near-field communication (NFC) interface for contactless payments, and a smartcard reader for EMV transactions. A particular merchant may have a single point-of-sale for interfacing with all types of payment vehicle, or different forms of point-of-sale for different payment vehicles. In some embodiments, point-of-sale 208 is a software program running on a server, and is operable to receive account information over the Internet for e-commerce transactions. Point-of-sale 208 also communicates, directly or indirectly, with one or more interchanges such as interchange 210. Point-of-sale 208 may further be in a fixed location (such as a retail store) or mobile (as in the case of a credit-card terminal carried by a delivery driver). In some embodiments, merchant point-of-sale 208 includes location services functionality as discussed elsewhere.

Interchange 210 in turn interfaces between merchant points-of-sale and financial institutions such as financial institution 212. It is the function of interchange 210 to communicate to point-of-sale 208 whether the transaction is authorized or rejected. In some embodiments, this role is performed by, for example, a credit card interchange for credit card transactions or an automated clearing house (ACH) for debit transactions. The interchange 210 receives information for the transaction from merchant point of sale 208. In some embodiments, this information may include location information for user 202, payment vehicle 204 and/or point-of-sale 208. Interchange 210 determines the issuing financial institution for payment vehicle 204, queries the issuing financial institution 212 using the transaction information to determine whether the transaction is approved or declined, and conveys this result to merchant point-of-sale 208.

In addition to determining whether user 202's account has sufficient funds for the transaction being processed, financial institution 212 may also perform additional validation of the transaction. For example, financial institution may compare the present transaction to user 202's account history to determine a likelihood of the transaction being fraudulent. Similarly, financial institution 212 may also validate payment vehicle 204 itself, to verify that it is in an active state. Payment vehicle 204 may be deactivated for a number of reasons: for example, if a new card is mailed to user 202, the card may be in a deactivated state until user 202 calls financial institution 212 to activate it. Payment vehicle may also be manually deactivated if user 202 reports it lost, in order to prevent unauthorized transactions.

In embodiments of the invention, the approval or rejection of the transaction may additionally be affected by location rule engine 214. Location rule engine 214 receives as inputs locations for user 202, payment vehicle 204 and/or merchant point-of-sale 208 (which, in some embodiments, may also be thought of as the location of the transaction). These locations, in combination with user 202's specifications of permitted locations (as stored in location rules data store 216) can then be used to approve or reject a transaction, or to override a previously determined approval or rejection. As described in greater detail below, user 202 can specify that transactions should be allowed or rejected based any of these locations, or on their relative proximity to each other. For example, a user could specify that, if the transaction location and the payment vehicle location are both out of a user-defined “home region” then the transaction is to be rejected unless the user location is within ten feet of the payment vehicle location. Other rules are discussed in greater detail below with respect to interface 218.

Location rules data store 216 stores location rules specified by user 202 or otherwise determined by the system for payment vehicle 204. In some embodiments, a single location rules data store stores rule data for all users, regardless of the financial institution 210 that issued payment vehicle 204. In other embodiments, each financial institution has its own location rules data store or multiple location rules data stores. In still other embodiments, location rules data store 216 (and, in some such embodiments, location rule engine 214) are stored on payment vehicle 204 itself, thereby allowing payment vehicle 204 to activate and deactivate itself based on the user-defined rules. In some embodiments, location rules data store 216 may optimize rules specified by the user to remove redundant regions, or to improve lookup time needed to determine whether a payment vehicle is active. For example, if a user specifies that a payment vehicle is to be deactivated within two overlapping regions then location rules data store 216 may combine the overlapping regions into a single region. Similarly, where the user specifies more complex rules using interface 218, as discussed below, related rules may be combined or factored to reduce lookup time.

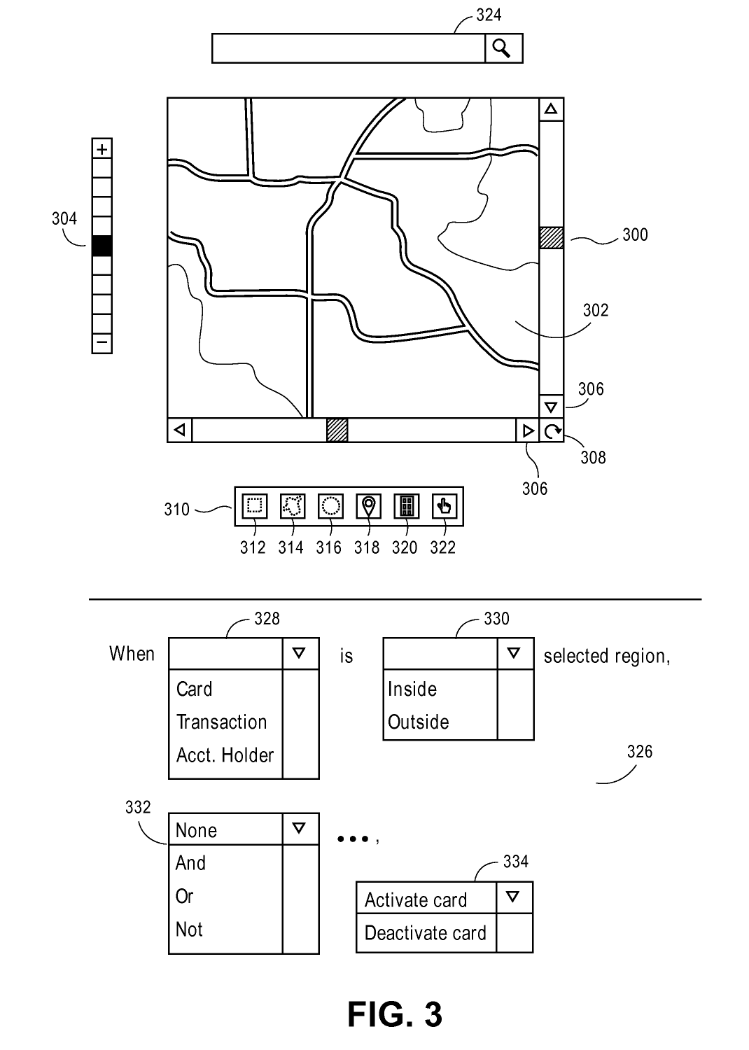

The user may populate location rules data store 216 in a variety of ways. For example, interface 218, described in greater detail below with respect to FIG. 3, allows user 202 to add, edit, or delete location rules for payment vehicle 204. In some embodiments, user 202 accesses interface 218 by logging onto the website of financial institution 212. In other embodiments, interface 218 is provided on an app in the user's personal telecommunications device and a location can be specified by giving a radius from the current location thereof. In still other embodiments, interface 216 is provided to employees of financial institution 212, and user 202 can specify their desired rules to that representative by phone. In some embodiments, the user can interact with location rules data store 216 without going through interface 218. For example, financial institution 212 may set up a SMS gateway that allows user 202 to activate or deactivate payment vehicle 204 for a given proximity of the current location by sending appropriate text messages. Other ways of allowing user 202 to interact with location rules data store 216 and location rules engine 214 are also contemplated as being within the scope of the invention.

Turning now to FIG. 3, an exemplary interface in accordance with certain embodiments of the invention is depicted, and referred to generally by reference numeral 300. As depicted, interface 300 includes map display 302 together with controls such as scale slider 304 and scrollbars 306. Map display 302 depicts part or all of a map for a given region, which may be of arbitrary size. For example, map display 302 could display a particular region of a city centered on city hall and one mile on a side. Using the controls, the region and scale of the displayed portion can be changed by a user of interface 300. For example, in some embodiments, the user could increase the area depicted in map region by moving scale slider 304 towards the minus icon, or decrease the area depicted (and thereby increase the level of detail shown) by moving the scale slider towards the plus icon. In such an embodiment, the user might also be able to pan the area depicted left, right, up, or down using scroll bars 306 in the usual manner known in the art. Thus a user could adjust the region described above to one centered one mile west of city hall and three miles on a side using scale slider 304 and scrollbars 306 appropriately. As depicted, map display 302 is oriented conventionally; i.e., such that north is up. In some embodiments, a rotation control 308 may also be present to allow the user to change the orientation of the displayed map region. In some such embodiments, rotation control 308 is a button that, when clicked, rotates the displayed map region by 90 degrees. In other such embodiments, rotation control 308 is a continuous control that allows arbitrary rotations of map display 302.

One of skill in the art will appreciate that scale slider 304, scrollbars 306, and rotation control 308 allow the user to display any desired portion of the map. Alternate control schemes can also be used. For example, in the case where interface 300 is used on a device with a touch screen, it may be the case that the function of scale slider 304 is instead (or in addition) made available via a pinch gesture. Thus, a user touching the screen with two fingers while bringing the fingers closer together would zoom out on the displayed region, while touching the screen with two fingers while moving the fingers apart would zoom in on the displayed region. Similarly, touching the screen with a single finger while moving the finger in a direction could scroll the display in that direction, and touching the display with two fingers while rotating them around a common center could change the orientation of the map region. One of skill in the art will recognize that many other schemes for controlling the displayed map region can be used, and all such schemes are contemplated as being within the scope of the invention.

Also present in interface 300 as depicted is selection toolbar 310, which allows a user a number of options for selecting particular regions of the displayed map display 302. These selected regions can then be used to create location rules, as discussed in greater detail below. For example, marquee tool 312 allows a user to click at one corner of a desired region, drag to an opposite corner, and release the click to select the corresponding rectangular region. Similarly, lasso tool 314 allows the user to select an arbitrarily shaped region using the mouse, and radius tool 316 allows the user to select an area within a certain distance of a given point by clicking on the center and dragging to the desired radius. Other region selection tools, as known in the art, may also be included in selection toolbar 310.

In some embodiments, other, more specialized tools may also be present in selection toolbar 310. For example, current location button 318 may also be included. Rather than simply selecting a region of the displayed map area, current location button 318 may also manipulate the displayed map region such that the current location (of user 202, payment vehicle 204 and/or a present transaction) is displayed in map display 302. In some embodiments, this also manipulates the scale of map display 302 so as to better display the location. The user can then select a region of appropriate size surrounding the current location. In some such embodiments, successive clicks of current location button select regions of increasing size. For example, clicking current location button 318 once might select the building of the current location, clicking a second time might select the block of the current location, clicking a third time might select the neighborhood, and clicking a fourth time might select the current city.

Another such tool that may be included in location toolbar 310 is building selection tool 320. Building selection tool 320 can be used at an appropriate zoom level to select or deselect an individual building displayed in map display 302. Thus, for example, a user could create rules that apply to only a single store, or to a general region excluding a specific store. Also present in the depicted location toolbar 310 is pan tool 322 which does not select a region but rather allows the user to manipulate map display 302 by clicking and dragging it. In some embodiment, the map region can also be zoomed using a scroll wheel when the pan tool is selected. Also of use for manipulating map display 302 is search box 324. By entering a search term in search box 324, map display 302 can automatically display the location (or a nearby location) matching the search term. In some embodiments, locations matching the search term are automatically selected. For example, a use could enter “liquor store” into the search box to automatically select all (or all nearby) liquor stores. Other tools for manipulating map display 302 and selecting a region will be immediately apparent to one of skill in the art upon reading this disclosure, and all such tools are contemplated as being within the scope of the invention. In some embodiments, once a user has selected a region, they can specify a name for the region for future reference when creating rules.

In some embodiments, the user may be able to indicate geographic regions without using a map interface. For example, a natural language interface may be used for selecting the geographic region. In such an interface, the user can specify the name of a location and the system can automatically determine the geographic region. For example, the user could specify “Las Vegas” and the system would create a geographic region corresponding to the Las Vegas city limits. Similarly, the user could specify “liquor stores” (or other merchant type) and a geographic region corresponding to each building containing a liquor store would be created. In some such embodiments, the resulting geographic region is displayed on a map for the user to confirm. The natural language interface may also recognize a variety of locations personal to the user, such as “home” and “work.”

Once the user has selected the desired region or regions, a rule can be constructed for that region using form 326. As displayed, form 326 includes a number of fields for flexibly constructing rules; however, in some embodiment, a simpler interface may be provided. For example, a user may be able to simply click on a region once selected in order to enable or disable the payment vehicle within the region. Such a simplified interface can be employed instead of or in addition to the depicted form 326. As depicted, once the user has selected the desired region in map display 302, they can use dropdown 328 to specify whether the region is applicable to user 202, payment vehicle 204 or a pending transaction. For example, in the example given above where a user wishes to disable their card when they travel to Las Vegas, they might select the city of Las Vegas as the region, and then indicate that the region applies to the user. Thus, another authorized user of the card could use the card while in Las Vegas, and the user could not make even card-not-present transactions while in Las Vegas. As discussed above, the location of the user may be determined using (for example) personal location device 206. The location of payment vehicle 204 can be determined in a number of ways depending on how it is embodied. For a conventional retailer, the location of the transaction might be the retailer's physical location. For an online transaction, the location of the transaction may be the location of the computer used to make the transaction, the headquarters of the online retailer, or the location of the server servicing the request in various embodiments.

For convenience, the user may user dropdown 330 to specify whether the rule applies inside or outside the selected region. Thus a user could specify that the card is to be deactivated whenever the user is outside of their hometown (e.g., when they are traveling). Alternatively, a user may wish to specify that their card should be deactivated whenever it is not in the same region as the user. In some embodiments, one or more additional options may be provided in dropdown 330 to concisely specify such preferences. For example, dropdown may contain such options as “with user” and “near transaction” when “card” is selected in dropdown 328. Thus a user could specify that when they are in a particular region, they must be with the card for it to be activated, or that the card and the transaction must be co-located (similar to prohibiting card-not-present transactions).

In some embodiments, the user may be able to create more complex rule through the use of Boolean operators. For example, a user may wish to activate their card for transactions in their home town only when they are also in the home town. Such a rule (with identical or different regions for different clauses of the rule) can be specified using dropdown 332, which provides the ability for the user to specify a Boolean operator for a successive clause. In some embodiments, this allows the user to specify a new region using map display 302. In other embodiments, users can specify previously named map regions in multiple clauses. Finally, form 326 includes a dropdown 334 specifying an action to take when the rule is matched. In some embodiments, options for action dropdown 334 include “activate card” and “deactivate card.” In other embodiments, the options include “allow transaction” and “prohibit transaction.” In still other embodiments, the options include “activate card” and “deactivate card” where box 328 indicates that the rule applies to a card or user, and “allow transaction” and “prohibit transaction” where the rule applies to the transaction itself.

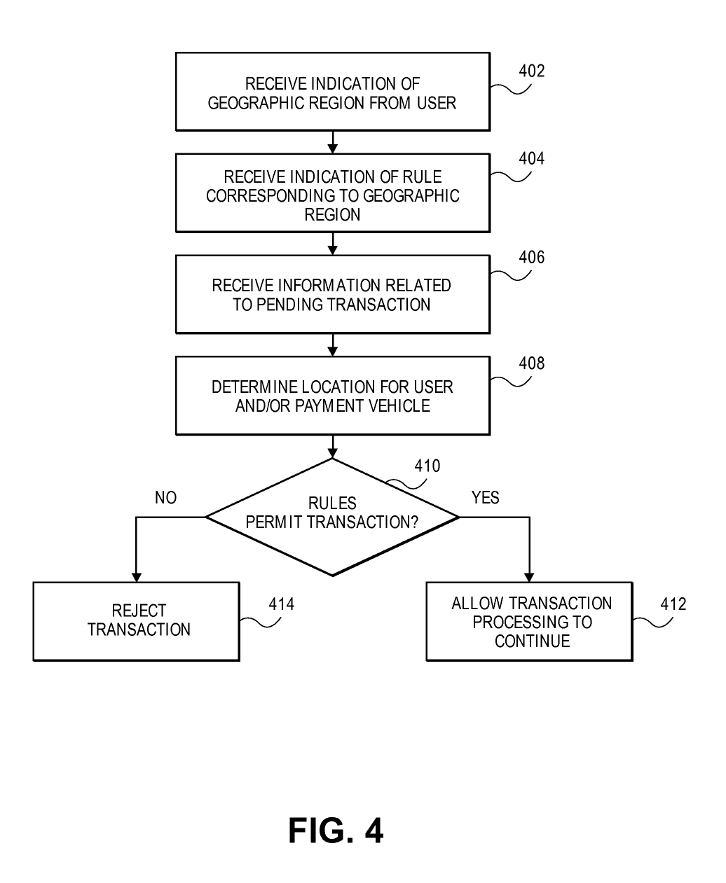

Turning now to FIG. 4, a flowchart illustrating the operation of an exemplary method in accordance with embodiments of the invention is depicted, and referred to generally by reference numeral 400. Initially, at a step 402, an indication of a geographic region is received from a user. As discussed above, this geographic region may be large enough to include an entire country or multiple countries, or smaller than a single merchant. The regions selected may be contiguous or comprised of multiple smaller regions. In some embodiments, the boundaries of the geographic region may correspond to a preexisting region, such as a building, city, or state. In other embodiments, the boundaries may be geometric or defined with respect to particular geographic coordinates.

Next, at step 404, a rule corresponding to the geographic region is received from the rule. Location rules were described in greater detail above with respect to FIG. 3, and broadly indicate an action to take when one of the elements of the transaction is within (or outside of) the geographic region specified in step 402. In some embodiments, this rule is stored in a data store such as location rules data store 216.

Some time later, at step 406, transaction information pertaining to a pending transaction is received. In some embodiments, this information will include a location for the transaction (which, as described above, may correspond to the location of the purchaser or the location of the merchant when they are not located in the same place). In some embodiments, this may occur once the transaction has otherwise been approved (e.g., the funding account has sufficient funds for the transaction). In other embodiments, this may occur as a part of the transaction approval process. The location for a merchant may include the GPS coordinated of the merchant, the merchant type (e.g., “coffee shop”), the merchant name (e.g., “Starbucks”), or the particular merchant location (e.g., “Starbucks #12031”).

Next at a step 408, location information for user 202 and/or payment vehicle 204 is received in some embodiments. As described above with respect to FIG. 2, location information for the user may be determined based on personal location device 206 and/or a peripheral in communication with it, or in any other way. The location information for payment vehicle 204 can be received form payment vehicle 204 itself, from merchant point-of-sale 208, or in any other fashion.

Processing then proceeds to decision 410, where is it determined whether the user's rules allow the transactions. Here, rules specified by the user are examined in turn first to see whether they apply to the transaction, and if so, to see what action to take in response. As described above, rules may place conditions on the location of the user, the payment vehicle and/or the pending transaction. In some embodiments, more or fewer geographic conditions than those described may be available. Once the relevant positions of the user, payment vehicle, and transaction are known, the regions for each rule can be examined to determine which, if any regions are relevant. In some embodiments, if regions overlap, rules for the larger region are evaluated first, and can then be overridden by rules for the smaller region. In other embodiments, where rules conflict, any rejection for the transaction (or deactivation of the card) takes precedence over any allowance of the transaction (or activation of the card). If the transaction is to allowed, processing proceeds to step 412; otherwise processing skips to step 414.

At step 412 the transaction is allowed (or the card is activated). In some embodiments, this simply means that the transaction proceeds as known in the art and is not blocked by location rule engine 214. In other embodiment, a message explicitly permitting the transaction is sent to financial institution 212 or interchange 210. If, instead, decision 410 determined that the transaction is to be rejected, processing skips to step 412 where merchant point-of-sale 208 and/or user 202 is notified of this rejection. In some embodiments, this rejection uses the conventional “transaction declined” signaling, while in other embodiments, a new mechanism is used to communicate the reason for the rejection of the transaction. In some embodiments, the user is informed of the rejection via a text (e.g., SMS) message sent to personal location device 206. In other embodiments, the user is informed via a push notification sent to an app running on personal location device 206.

For the sake of providing a further illustration of the operation of embodiments of the invention, an exemplary scenario is provided. The description of the operation of one embodiment of the invention below should not be construed as constraining the scope of the invention as a whole. Initially, a new customer of a financial institution opens a prepaid card account. As a part of the account creation process, a customer-service representative helps the user configure a basic set of rules. First, the user's son is currently away a college and is listed as an authorized user of the account for emergencies. However, the user does not want their son to be able to the account for online purchases. Accordingly, a first rule is established that the son's particular card accessing the prepaid account can only be used when the transaction is located in the son's hometown. Next, the user does not wish to be tempted to gamble at a local casino, so a second rule is put in place deactivating the card when the user is within 50 feet of the casino. Finally, to prevent fraud, a third rule is put in place such that the card is deactivated when it is in a different building from the user.

Some time later, the user purchases a coffee at Starbucks, paying using the card. While drinking the coffee, the user's wallet falls on the ground and is stolen by a thief. The thief the goes to another Starbucks a few blocks away and attempts to make a purchase. Because of the third rule, the attempt fails because the user's position (as determined by their smartphone) does not match that of the card (as reported by the point of sale), even though both the user and the thief are at Starbucks locations. Note that this works even if the thief attempts to make the purchase before the user even knows that their wallet has been stolen, and before they have reported it stolen.

Some further time later, the user's son's car breaks down on a road trip. Because the user is not in his hometown, when he attempts to use his card to pay for car repairs, the transaction is rejected. After being called by their son, the user uses the app on their smartphone to modify the rules being applied to the son's card, such that transactions are allowed in the son's hometown, or when the son, the son's card, and the transaction are all in the same place. Based on this updated rule, when the son resubmits the transaction, it is approved because he and the card are both at the mechanic where the transaction is taking place.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for location-based activation and deactivation of a payment vehicle, comprising:
a user interface for allowing a user to specify a geographic region and a rule corresponding to the geographic region;
a location rules data store operable to store the geographic region and the rule;
a location rules engine operable to:
receive information for a transaction;
determine a location for the transaction; and
determine whether the transaction should be allowed or denied based at least in part on whether the location for the transaction is within the geographic region and the rule.

2. The system of claim 1, wherein the step of determining whether the transaction should be allowed or denied is further based on a position of the user.

3. The system of claim 2, wherein the step of determining whether the transaction should be allowed or denied is further based on a position of a payment vehicle used to fund the transaction.

4. The system of claim 1, wherein the step of determining whether the transaction should be allowed or denied is further based on a position of a payment vehicle used to fund the transaction.

5. The system of claim 1, wherein the user interface is operable to allow the user to specify the geographic region based on a position of the user when accessing the user interface.

6. The system of claim 1, wherein the geographic region consists of one element of the group consisting of a single building and a city.

7. The system of claim 1, wherein the geographic region is selected using a natural language interface.

8. The system of claim 1, wherein the geographic region is specified by indicating a center and a radius for a circle.

9. A method for allowing or denying a transaction based on location, comprising the steps of:
receiving information for the transaction;
determining a location for a payment vehicle being used to fund the transaction and associated with a user;
determining a location for the user;
determining whether the transaction should be allowed based at least in part on a proximity between the user and the payment vehicle.

10. The method of claim 9, wherein the location of the user is determined based on a location determined for a personal telecommunications device associated with the user.

11. The method of claim 9, wherein the location of the payment vehicle is determined by a GPS receiver integrated into the payment vehicle.

12. The method of claim 9, wherein the payment vehicle is a prepaid card.

13. One or more computer-readable media storing computer-executable instructions which, when executed by a processor perform a method of allowing or denying a transaction based on the location of a user, comprising the steps of:
receiving, from a user, an indication of a geographic region;
receiving, from a point-of-sale, information for a transaction;
determining a location for the user;
allowing or denying the transaction based at least in part on whether the user is within the geographic region.

14. The media of claim 13, wherein the method further comprises the step of determining a location for the transaction, and wherein the step of allowing or denying the transaction is further based on the location for the transaction.

15. The media of claim 14, wherein the method further comprises the step of determining a location for a payment vehicle funding the transaction, and the step of allowing or denying the transaction is further based on the location for the payment vehicle.

16. The media of claim 13, wherein the location for the user is determined based on a location for a personal telecommunications device associated with the user.

17. The media of claim 13, wherein the geographic region is rectangular.

18. The media of claim 13, wherein the geographic region is of arbitrary shape specified by the user.

19. The media of claim 13, wherein the method further comprises the step of communicating, to the user, that the transaction was rejected on the basis of the user's location.

20. The media of claim 19, wherein the step of communicating includes sending an SMS message.
